(19) United States
(12) Patent Application Publication
(10) Pub. No.: US 2007/0124142 A1
(43) Pub. Date: May 31, 2007

(54) Voice enabled knowledge system

(76) Inventor: Santosh Kumar Mukherjee, Bloomfield, NJ (US)

Correspondence Address: ASHOK TANKHA;OF COUNSEL, LIPTON, WEINBERGER & HUSICK, 36 GREENLEIGH DRIVE, SEWELL, NJ, 08080, US

(21) Appl. No.: 11/287,139

(22) Filed: Nov. 25, 2005

(51) Int. Cl. G10L 15/26; G10L 13/08

(52) U.S. Cl. 704/235; 704/260

(57) ABSTRACT

This invention discloses a voice enabled knowledge system, comprising a speech recognition engine and text to speech engine. The speech recognition engine further comprises a representation unit to represent the spoken words, a model classification unit to classify the spoken words, a training database to match the spoken words with preset words and a search unit to search for the spoken word in said training database, based on the results of said model classification. The text to speech engine for conversion of an input text to speech, comprises a text pre-processing unit for analyzing the input text in a sentence form, a prosody unit for word recognition using said acoustic model, a concatenation unit for converting the diphone equivalents into words and thereafter into a sentence and an audio output device for speech output.

### BACKGROUND OF THE INVENTION

Currently, complex graphical user interfaces (GUIs) enable users to take advantage of the computer's graphic capability to conduct multiple tasks simultaneously. However, these systems are often mouse and keyboard constrained. Also, this mode of information communication and retrieval is inconvenient for users who are traveling and for those who find it difficult to use the keyboard. There is a need for building in voice interfaces into existing textual information systems that can provide an accessible solution for users who are traveling, and for busy executives, physically disabled users, customer service representatives, etc.

Typically, the usability and interaction features of software applications are designed with only the visual communication mode in mind. It is difficult to add a voice dimension to the user interaction of these software applications, especially if the software applications are of disparate types and formats. In typical computer or data processing systems, user interaction is provided using only a video display, a keyboard, and a mouse. Additional input and output peripherals are sometimes used, such as printers, plotters, light pens, touch screens, and bar code scanners; however, the vast majority of computer interaction occurs with only the video display, keyboard, and mouse. Human-computer interaction is enabled through visual display and mechanical actuation. However, a significant proportion of human interaction is verbal and voice provides a much richer mode of communication compared to visual text. It is desirable to facilitate verbal human-computer interaction to increase the efficiency of user interfaces.

Current speech recognition systems and text to speech conversion systems are capable of providing a user who is located at a site remote from his or her personal computer, information such as calendar events, electronic mail messages via speech, etc. These systems have been developed to provide some form of verbal human-computer interactions, ranging from simple text-to-speech voice synthesis applications to more complex dictation and command-and-control applications.

The communications scenario across the world has changed dramatically over the last few years. This revolution has been ushered in by the entry of mobile-phones in the world market. These wireless devices not only allow the individual to be free from the mobility restrictions imposed by conventional wire line phones, but it has also introduced the short-message-service (SMS). This SMS service has spawned numerous applications, for example, person-to-person message exchange, mobile-banking, bill-payment reminders, etc. Adding a voice dimension to SMS text message improves the effectiveness of SMS messaging. The proliferation of cellular telephony, wireless internet enabled devices, laptop computers, handheld personal computers and various other technologies have helped create a mobile virtual office work environment for many. The invention of laptop computers, handheld personal computers and other technologies has made office and other information accessible during travel. However, there still exists an opportunity to enable greater mobility, especially through the use of text to voice conversion tools in mobile applications of the above devices.

There are a number of challenges faced by current text to voice or speech, and voice to text conversion applications. The speed of response and accuracy are critical parameters for the effectiveness of such conversion systems. Most of the current conversion applications are only selectively applicable, for example some of these applications can read out documents of a specific format. There is need to improve the usability options of text to voice conversion systems, such as providing the options of customizing the pitch, reading speed, reading volume of a selected voice, etc.

One method of addressing the constraints of current speech to text conversion systems is to provide larger predetermined vocabularies. This approach will however demand larger system resources and require powerful algorithms to effect accurate media conversions. Though there are current speech recognition that are both speaker independent and capable of recognizing words from a continuous stream of conversational speech, there still lies an opportunity to improve the effectiveness of the process of individualized speaker enrollment and training prior to effective use.

There is an unmet market need for a text to voice tool that can read text from any hypertext mark up language (HTML) document or web page, Microsoft Word and Microsoft PowerPoint of Microsoft Inc., and Adobe Acrobat of Adobe Systems, Inc. There is a need for a tool that can custom the pitch, reading speed, and reading volume of a selected voice. Also, there is a need to provide an executive organizer that allows a user to set up personal details for greeting messages, event or appointment reminders, etc. There is a need for text-to-wave recording, wherein the user can record any text into an audio file with customized voice and speed details. There is a need for a tool that searches the world-wide web using voice commands and creates voice enabled business critical information, data entry forms, e-commerce applications etc..

### SUMMARY OF THE INVENTION

The proposed invention and all its embodiments herein will be referred to as a voice enabled knowledge system (VEKS) engine.

This invention discloses a voice enabled knowledge system, comprising a speech recognition engine and text to speech engine. The speech recognition engine further comprises a representation unit to represent the spoken words, a model classification unit to classify the spoken words, a training database to match the spoken words with preset words and a search unit to search for the spoken word in said training database, based on the results of said model classification. The text to speech engine converts an input text, for example a PDF file, a Microsoft Word document, etc., to speech or a voice enabled system. The text to speech unit comprises a text pre-processing unit for analyzing the input text in a sentence form, a prosody unit for word recognition using an acoustic model, a concatenation unit for converting the diphone equivalents into words and thereafter converting the diphone equivalents to a sentence or speech output through an audio output device. The Veks engine has in-built characteristics and application characteristics. The VEKS software is used in specific applications in specific domains for example, the legal domain, the medical domain, etc.

One object of the VEKS engine is to read text from any hypertext mark-up language (HTML) document or web page, for example, Microsoft Word and Microsoft PowerPoint of Microsoft Inc., Adobe Acrobat of Adobe Systems, Inc., etc.

Another object of the VEKS engine is to read all the pages from a Microsoft word document and all the slides from a Microsoft power point file even while only one page or slide is visible in the active window.

Another object of the VEKS engine is to read from the position of the current cursor position and to read the selected or highlighted portion of text.

Another object of the VEKS engine is to generate abstracts of documents, for example, legal documents.

Another object of the VEKS engine is to provide the means to custom the pitch, reading speed, reading volume of a selected voice, etc.

Another object of VEKS engine is to enable voice recognition. The VEKS engine provides a voice-tune-up process, which helps the user to train the system with his or her voice and pronunciation and perfect the dictation.

Another object of the VEKS engine is to provide an executive organizer that allows a user to set up personal details for greeting messages, event or appointment reminders. The VEKS engine organizer also provides mute options. It allows the user to mute welcome notes, set up greeting messages and other types of instructions.

Another object of the VEKS engine is to provide a phone book with information such as names, phone numbers, mobile phone numbers, etc. The VEKS engine phone book provides the list of the names entered in electronic organizers. The user can hear the contact numbers voicing the name of the contact.

Another object of the VEKS Engine is to provide a text-to-wave recorder. The user can record any text into an audio file with customized voice and speed details.

Another object of the VEKS engine is to store messages in a central server for later retrieval in a mobile device. The VEKS engine allows messages to be sent out at a preset date and time.

Another object of the VEKS engine is to provide voice enabled internet access on mobile phones or any wireless web enabled device.

Another object of the VEKS engine is to search the world-wide web using voice commands and to create voice enabled business critical information, data entry forms, e-commerce applications etc.

Another object of the VEKS engine is to provide a voice tune up process, wherein the pronunciation and dictation can be fine tuned in the voice recognition process.

### BRIEF DESCRIPTION OF THE DRAWINGS

FIG. 1 illustrates the architecture of the VEKS engine.

FIG. 2 illustrates the components of the speech recognition engine.

FIG. 3 illustrates the components of the text to speech engine.

FIG. 4 illustrates the components of the text pre-processing unit.

FIG. 5 illustrates the components of the prosody unit.

FIG. 6 illustrates the functional architecture of the VEKS engine.

FIG. 7 illustrates the functional architecture for wireless applications that use the VEKS engine.

FIG. 8 illustrates the block diagram for an artificial intelligence chat system that uses VEKS engine.

FIG. 9 illustrates the block diagram for a text summarizer that uses the VEKS engine.

FIG. 10A and FIG. 10B illustrates the operational flowchart for the VEKS engine.

### DETAILED DESCRIPTION OF THE INVENTION

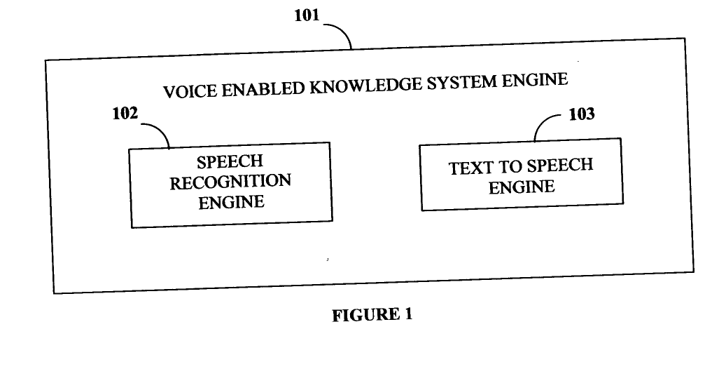

FIG. 1 illustrates the architecture of the VEKS engine 101. The VEKS engine 101 consists of two primary systems: a speech to text engine comprising a speech recognition engine 102, and a text to speech engine 103. Basically, the VEKS engine performs two functions. One function is to recognize speech and to convert the speech into text which can then be edited, e-mailed, etc. The second function of the VEKS engine is to convert text into speech.

The speech to text engine converts the speech of any individual, comprising varying tones and frequencies, into text. The speech recognition engine 102 first recognizes the signal generated by the spoken words in the speech, and then the speech to text engine of the VEKS engine converts the recognized speech into text.

The text to speech engine 102 of the VEKS engine 101 audio enables electronic text documents, i.e., it converts a text document into speech. The speech to text engine of the VEKS engine 101 provides options to read highlighted text, summarize, audio record and edit text documents.

Media conversion systems continuously adapt to changing conditions, such as the use of new speakers, microphone, etc. The VEKS engine 101 adapts itself to such changing conditions. The effectiveness of the VEKS engine improves through repeated use. Such adaptation can occur at many levels, such as in systems, sub-word models, word pronunciations, language models, etc.

The VEKS engine 101 uses statistical language models to reduce the search space and resolves acoustic ambiguity. The VEKS engine 101 also incorporates syntactic and semantic constraints that cannot be captured using purely statistical models.

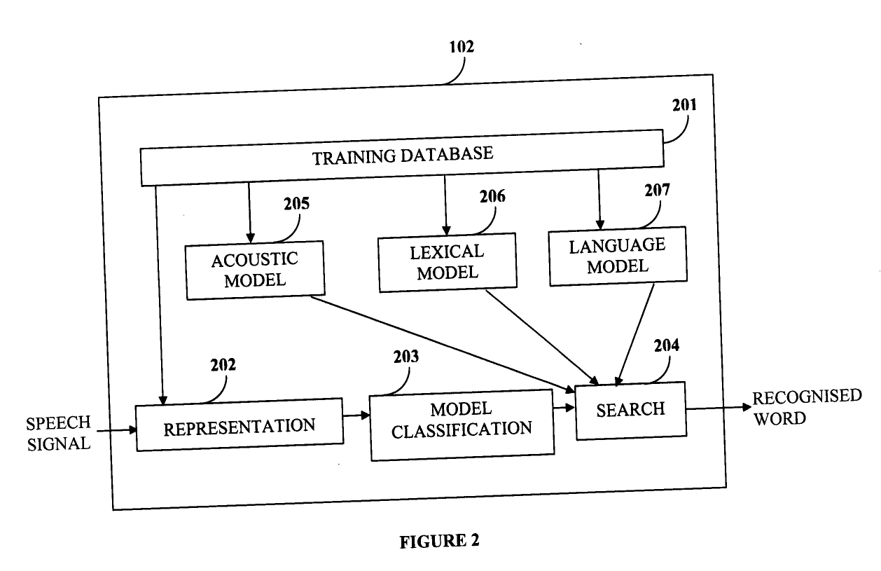

FIG. 2 illustrates the components of the speech recognition engine 102. The main function of the speech recognition engine 102 is to recognize the user's tone, pitch, accent and other speech characteristics, thereby optimizing voice recognition.

The input speech signal in the form of spoken words is given to a representation unit 202 which is a part of the process of recognition of words. The representation unit is the first component for accepting the signals of the speech. The representation unit has two components—a component to accept the speech signal, and a component to recognize the words by a voice recognizer. The speech recognition engine 102 has a training database 201 that contains preset words and phrases against which spoken words are matched. The training database 201 provides an appropriate pre-assigned word for the incoming spoken word. The output of the training database 201 is further broken down into acoustic, lexical and language properties. The chosen preset word's acoustic, lexical and language properties are specified by the acoustic model 205, lexical model 206 and language model 207 respectively. The model classification unit 203 classifies the spoken word into using three models for recognition of the word, namely an acoustic model 205, a lexical model 206 and a language model 207. The acoustic model 205 is used for recognition of the pitch and flow of speech. The lexical model 206 is used for recognition of punctuations and context of speech. The language model 207 is used for information classification. The search unit 204 compares the acoustic, lexical and language properties initiated from the training database 201 with those from the model classification unit 203. The recognized textual word is stored against the spoken word in the training database 201 for future reference.

The speech recognition engine 102 assigns scores to hypotheses for the purpose of rank ordering them. These scores provide a good indication of whether a hypothesis is correct or not.

Most speech recognition systems are designed for use with a pre-defined or particular set of words, but not necessarily all the words in the system vocabulary. This leads to a certain percentage of out-of-vocabulary words that are not recognized during the normal course of conversation. The speech recognition engine 102 detects such out-of-vocabulary words, or will map a word from the vocabulary or an unknown word, to avoid errors. Speech recognition systems that are deployed for real use, deal with a variety of spontaneous speech phenomena, such as filled pauses, false starts, hesitations, non-grammatical construction and other common behaviors not found in read speech.

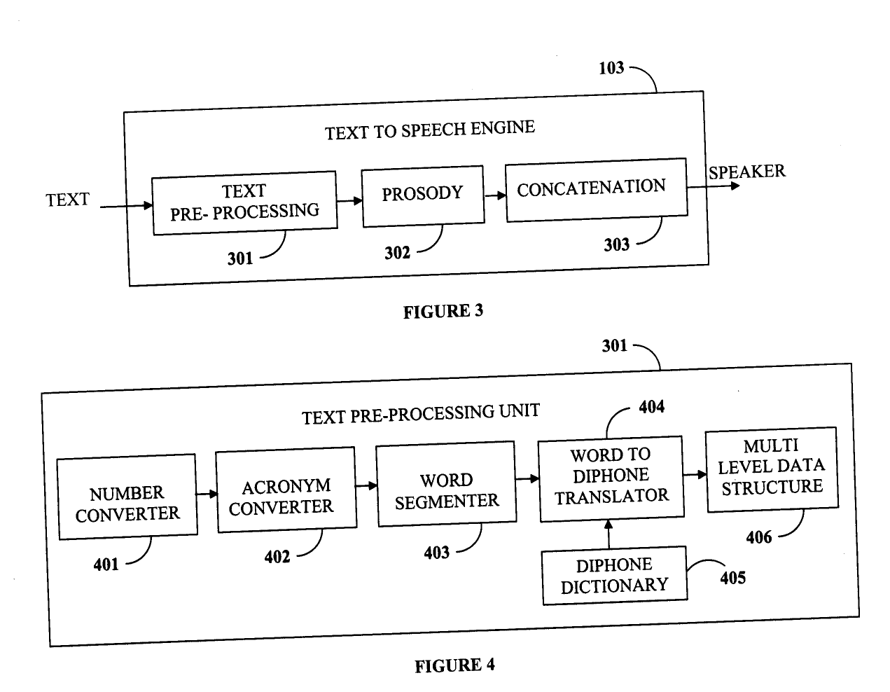

FIG. 3 illustrates the components of the text to speech engine 103. The text to speech engine 103 takes an input sequence of words in text format and converts them into speech. For example, it is used to convert words from a computer document into audible speech output through a speaker. The text to speech engine 103 optimizes the pitch, tone and other parameters of the output voice, according to the context of use and pronunciation. The text to speech engine 103 consists of a text pre-processing unit 301, a prosody unit 302 and a concatenation unit 303.

The prosody unit 302 captures the acoustic structure that extends over several segments or words. Stress, intonation and rhythm of the acoustic structure contain important information used for word recognition and for interpreting the user's intentions. The concatenation unit 303 converts the diphone equivalents into words and thereafter converts the diphone equivalents into a sentence. The concatenation unit 303 generates the human-like voice, providing a natural transition between sequential discrete sounds.

FIG. 4 illustrates the components of the text pre-processing unit 301. The input to the text pre-processing unit 301 are the spoken words in the form of a sentence. The text pre-processing unit 301 outputs the diphone equivalents of the input spoken words. A number converter 401 converts numbers to their textual equivalents. An acronym converter 402 converts acronyms and abbreviations into textual words. A word-segmenter 403 is used to fragment sentences into word segments. A word to diphone translator 404 converts words to their diphone equivalents by running a match in the diphone dictionary 405. A multi level data structure (MLDS) 406 is used for storing the diphone equivalents of the spoken words.

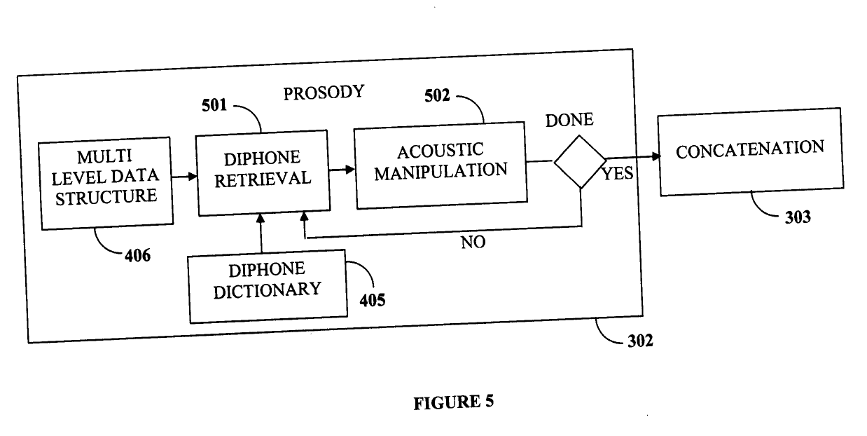

FIG. 5 illustrates the components of the prosody unit 302. The prosody unit 302 consists of a multi-level data structure (MLDS) 406, a diphone retrieval unit 501, an acoustic manipulation unit 502 and a diphone dictionary 405. The diphone retrieval unit 501 is used for retrieval of appropriate diphone equivalents from a diphone dictionary 405 and is matched with an appropriate file format. The retrieved diphones are stored in wave file formats. The acoustic manipulation unit 502 identifies the appropriate wave file formats.

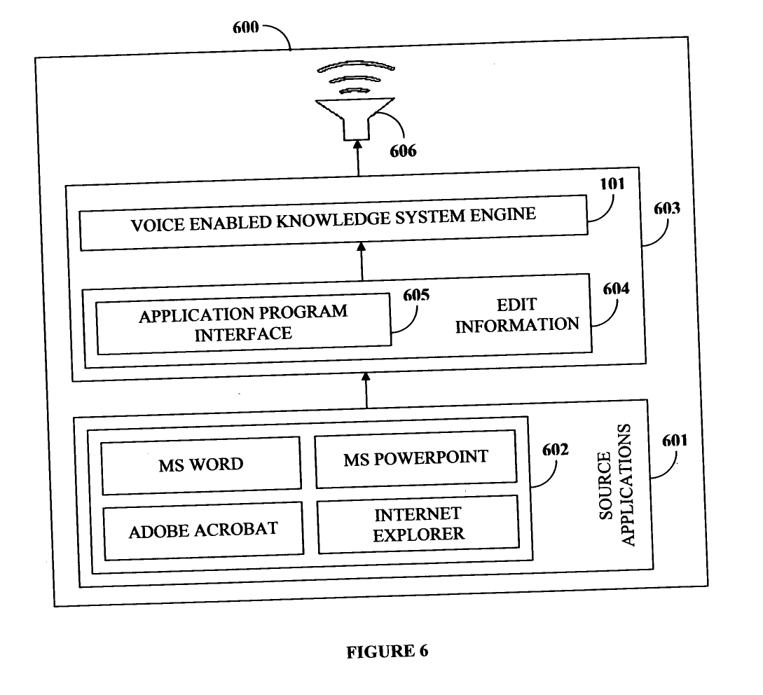

FIG. 6 illustrates the functional architecture of the VEKS engine 101. The main constituent of the VEKS architecture is the source application 601 containing text material 602. The VEKS engine 101 can process text of multiple formats such as Microsoft Word and Microsoft PowerPoint of Microsoft Inc., Adobe Acrobat of Adobe Systems Inc., etc. The VEKS application 603 contains an edit information unit 604 and an application program interface (API) 605. The edit information unit 604 provides the API 605 interfaces between the source application 601 and the VEKS engine 101. The output of the VEKS application 603 is fed to an audio output device 606 for example speakers, headphones, etc.

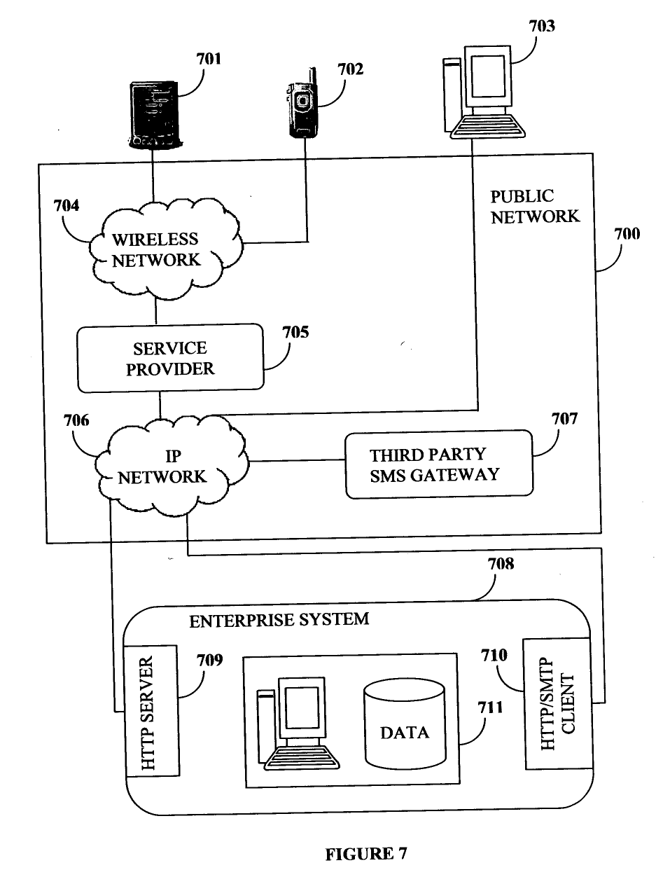

FIG. 7 illustrates the functional architecture for wireless applications that use the VEKS engine 101. The functional architecture consists of a public network 700 and enterprise system 708. The VEKS engine 101 can be installed in personal digital assistants (PDA) 701, mobile devices 702, or in personal computers 703. The VEKS engine 101 can perform multiple functions, for example, the VEKS engine 101 can generate voice outputs for incoming short message services (SMS) text messages in a mobile device. A public network 700 consists of a wireless network 704, a service provider 705, an internet protocol (IP) network 706 and a third party SMS gateway 707. A wireless network 704 is used to connect a PDA 701 via a service provider 705. An IP network 706 connected to the enterprise system 708 has a third party SMS gateway 707 that acts as a router between the mobile service and internet service providers. The enterprise system 708 contains a hypertext transfer protocol (HTTP) server module 709, a simple mail transfer protocol (SMTP) client module 710 and an enterprise server 711, which act as a message store. The HTTP server module 709 and the SMTP client module 710 are used for sending and receiving of messages. The typical mobile handset is often limited by the capacity of its internal memory or a subscriber identity module (SIM) memory to store a limited number of SMS messages. The VEKS application allows its subscribers to store and retrieve the messages on the enterprise server 711.

At times, there is a need to send specific messages to a target team. Conventionally, this is done by first storing all the recipients' numbers on the device, and then sending the stored message to each of the group members either manually, or by using an automated feature of the phone. The VEKS engine 101 allows users to define and maintain device groups on the enterprise system 708 for distributing messages.

Service providers 705 normally do not allow subscribers to send out a predefined message on a preset date and time. This feature is available in the VEKS engine 101 and empowers a user to set and send out predefined reminders to others. The VEKS engine 101 allows its subscribers to maintain an offline data store of a large number of contacts, which can be retrieved and stored locally as and when needed. The VEKS engine 101, in addition to short message service (SMS)-based interaction, allows access to the web using web-enabled devices.

FIG. 8 illustrates the block diagram for an artificial intelligence (AI) chat system that uses the VEKS engine 101. In one embodiment of this invention, an AI chat system is implemented for answering frequently asked questions (FAQ) of a customer. The customer 801 inputs text into a computer network 802 and the output generated by the VEKS engine 101 is a speech signal transmitted through audio output devices 606, such as personal computer speakers, headphones, etc.

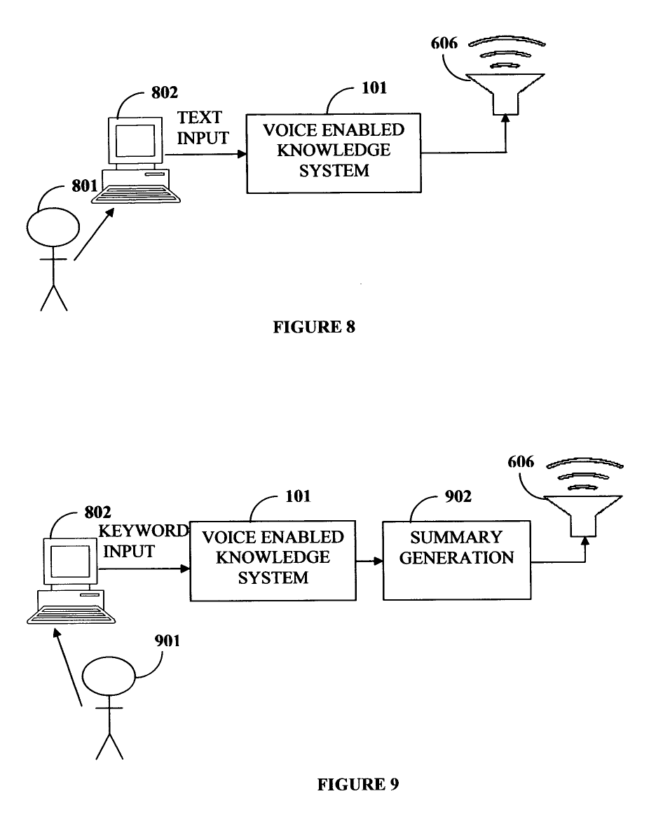

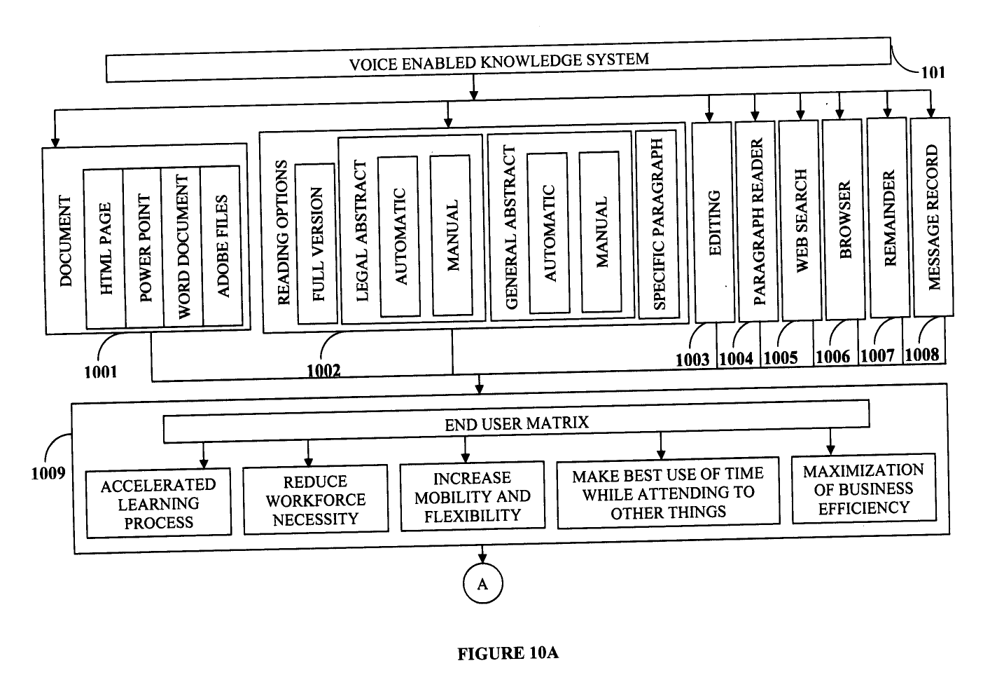

FIG. 9 illustrates the block diagram for a text summarizer that uses the VEKS engine 101. The text summarizer is used for summarization of electronic text documents and replays the text in voice format to the user. The user 901 inputs the keywords through a computer network 802 to a VEKS engine 101. The VEKS engine 101 first converts the full document into a summary document using a summary generation unit 902 and outputs a speech signal through an audio output devices 606 such as personal computer speakers, headphones, etc. The interface between the user's text input and speech output is the VEKS engine 101.

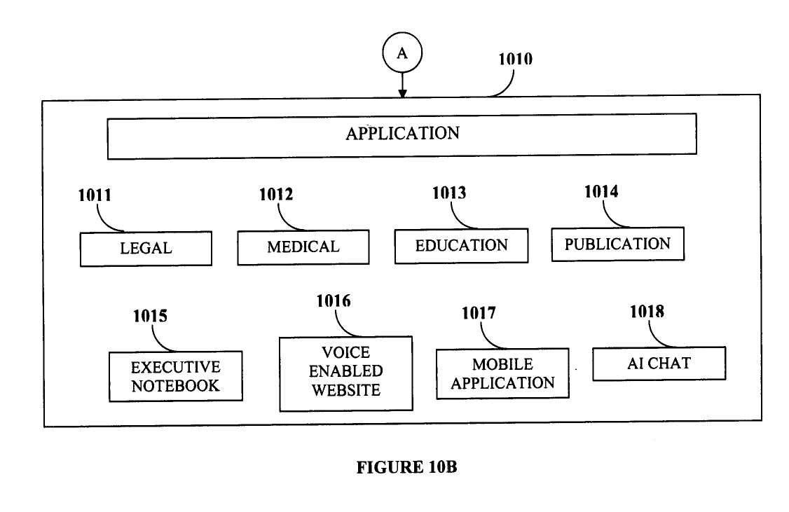

FIG. 10A and FIG. 10B illustrates the operational flowchart for the VEKS engine 101. The VEKS engine 101 converts text documents to speech output. The text documents, referred to as documents 1001, includes HTML pages, Microsoft Word and Microsoft PowerPoint of Microsoft Inc., Adobe Acrobat of Adobe Systems Inc., etc. The VEKS engine 101 offers the flexibility to choose among different reading options 1002. The reading options can be full version, legal abstract, general abstract or a specific paragraph. The full version reads out the entire document whereas the specific paragraph summarizes a chosen paragraph. The legal abstract option summarizes legal documents. General abstract summarizes all types of documents. The legal abstract as well as general abstract options allows the user to choose between automatic abstraction and manual abstraction. The automatic abstract document summarizes the document. The manual abstract searches the text document using keywords given by user.

The other functions of the VEKS engine 101 include editing 1003 documents, reading 1004 specified paragraphs, web searching 1005, browsing 1006 the internet, reminding 1007 and message recording 1008. The VEKS engine 101 provides an organizer which allows the user to set reminders for an event or meeting using the reminding 1007 function. The message record 1008 stores the SMS messages and the subscribers can retrieve the stored SMS messages at a later point in time.

The benefits of the VEKS engine 101 are shown in 1009. The VEKS engine 101 increases mobility as it can be installed on mobile devices. It provides the flexibility of voice enabling any format of text document. The user can use voice commands to interact with the VEKS engine 101. The VEKS engine 101 maximizes business efficiency and reduces time spent on interacting with information systems.

The fields of applications of the VEKS engine 101 are shown in 1010 which include legal 1011, medical 1012, education 1013, publication 1014, executive notebook 1015, voice enabled website 1016, mobile application 1017 and Al chat 1018. The application of the VEKS engine 101 in each of the above fields is explained below.

Legal 1011: Legal firms often deal with elaborate case studies, precedents and different laws on different subjects. They need to analyze these documents while they are working on a particular case or before a case hearing. The VEKS engine 101 allows an analysis of these documents wherein lawyers can hear a summarized version of the required document instead of having to read it in its entirety. The VEKS engine can read text from websites and from off-line documents. The VEKS engine 101 plays the role of an electronic personal assistant by providing lawyers the utilities of voice enabled reminders, phonebook, text (message) recorder, e-mail, dictation, voice commands, etc.

In the case of medical 1012 applications, the VEKS engine 101 provides added mobility to the health-care industry. The VEKS engine 101 can read the entire content of any document or website. Medical professionals can listen to a patient's case history and medical report. The VEKS engine 101 summarizes the entire medical document in voice format. The text to voice media conversions enabled by the VEKS engine 101 can be used in pharmacies for the accurate selection of medicines written in the prescription. The inter-medicinal reactions for a drug or issues with respect to certain allergies can be read out to the pharmacist.

In education 1013 applications, academicians use the VEKS engine 101 to summarize exhaustive documents, research papers, books, etc.

For publication 1014, the VEKS engine 101 can voice-enable the contents of the publication, for example, a newspaper. It will read the headlines or summarize and play the important news on different sections like sports, entertainment and other prominent sections.

For executive notebook 1015, the VEKS engine 101 provides a voice-enabled notebook for executives, for accessing the daily news from the most popular news websites, information about airlines, airports, travel agencies, local weather reports, nearest hospitals and nursing homes, etc. It can inform the executives about insurance policies, real estate, postal and voluntary services, etc. The VEKS engine 101 also provides special help lines in executive notebooks, such as medical first aid, legal advisors, police help, traveling tips, home delivery, etc.

For voice enabled website 1016, the VEKS engine 101 voice enables websites and improves the readability of web pages. Customer service can be voice enabled in e-commerce websites. A user can ask a question and the reply can be played in voice format.

For mobile applications 1017, the SMS service has spawned numerous applications, for example, person-to-person message exchange, mobile-banking to bill-payment reminders, etc. The SMS service can be voice enabled using the VEKS engine 101. The VEKS engine 101 allows the development of applications for mobile or wireless devices using state of the art technologies. Given the wide range of available wireless devices, the VEKS engine 101 is implemented with minimal dependency on specific device manufacturers or proprietary protocols or specifications.

For AI Chat 1018, the VEKS engine 101 provides an artificial intelligence (AI) chatting interface. The VEKS AI chat enables businesses to author and publish dynamic, database and logic driven characters for customer service applications. The result is a graphical character that replies in real time to users' questions and is voiced via VEKS integrated text to speech solution. The VEKS AI chat is a customizable application well suited for customer support, dynamic products, pricing and availability information, frequently asked questions (FAQs), knowledge base delivery, scheduling, trivia and entertainment applications.

I claim:

1. A system for converting speech to text comprising:
a speech recognition engine for understanding the spoken words of a user, further comprising:
a representation unit to represent the spoken words;
a model classification unit to classify the spoken words;
a training database to match the spoken words with preset words, and
a search unit to search for the spoken word in said training database, based on the results of said model classification.

2. A system for converting text to speech comprising:
a text to speech engine for understanding the spoken words of a user, further comprising:
a text pre-processing unit for analyzing the input text in a sentence form;
a prosody unit for word recognition using said acoustic model;
a concatenation unit for converting the diphone equivalents into words and thereafter into a sentence; and
an audio output device for speech output.

3. A voice enabled knowledge system, comprising:
a speech recognition engine for understanding the spoken words of a user, further comprising:
a representation unit to represent the spoken words;
a model classification unit to classify the spoken words;
a training database to match the spoken words with preset words,
a search unit to search for the spoken word in said training database, based on the results of said model classification; and
a text to speech engine for conversion of an input text to speech, further comprising:
a text pre-processing unit for analyzing the input text in a sentence form;
a prosody unit for word recognition using said acoustic model;
a concatenation unit for converting the diphone equivalents into words and thereafter into a sentence; and
an audio output device for speech output.

4. The tool to audio enable the documents of claim 3, wherein the training database further comprises:
an acoustic model to recognize the pitch and flow of the spoken word;
a lexical model to recognize the punctuations of the spoken word; and
a language model for information classification.

5. The voice enabled knowledge system of claim 3, wherein the text pre-processing unit further comprises:
a number converter to convert numbers to their textual equivalents;
an acronym converter to replace acronyms with their single letter components and convert abbreviations to their textual equivalents;
a word-segmenter to fragment sentences created from said input text into words;
a word to diphone translator to convert said words to their diphone equivalents;
a diphone dictionary to map diphones with the words; and
a multi level data structure for storing the diphone equivalents of the input text.

6. The voice enabled knowledge system of claim 3, wherein the prosody unit further comprises:
a diphone retrieval unit for retrieval of said diphone equivalents;
a diphone dictionary to choose the word corresponding to its diphone equivalent; and
an acoustic manipulation unit for recognition of appropriate file format.

7. The voice enabled knowledge system of claim 3, wherein said document includes hyper-text markup language documents.

8. The voice enabled knowledge system of claim 3, further comprising a summarizer to prepare and play the summary of an input request.

9. The voice enabled knowledge system of claim 3, wherein the text to speech engine reads out text highlighted on a document by a user.

10. The voice enabled knowledge system of claim 3, wherein the voice enabled knowledge system edits text documents.

11. The voice enabled knowledge system of claim 3, wherein the voice enabled knowledge system is installed in personal digital assistants, mobile devices and personal computers.

12. The voice enabled knowledge system of claim 3, wherein the speech recognition engine interprets the user's tone, pitch, accent and other speech characteristics.

13. The voice enabled system of claim 3, wherein the voice enabled system reads all the pages from a Microsoft word document and all the slides from a Microsoft power point file even while only one page or slide is visible in the active window.

14. The voice enabled system of claim 3, wherein the voice enabled system searches the world-wide web using voice commands and to create voice enabled business critical information, data entry forms and electronic commerce applications.

15. The voice enabled system of claim 3, wherein the voice enabled system provides a voice tune up process, wherein the pronunciation and dictation can be fine tuned during voice recognition.
